(19) United States
(12) Patent Application Publication
(10) Pub. No.: US 2010/0037156 A1
(43) Pub. Date: Feb. 11, 2010

(54) PROGRAM AS DEVELOPMENT TOOL KIT FOR SUPPORTING APPLICATION DEVELOPMENT

(75) Inventor: Yasuhiro Hosoda, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/507,736

(22) Filed: Jul. 22, 2009

(30) Foreign Application Priority Data
Aug. 6, 2008 (JP) 2008-203212

(51) Int. Cl. G06F 3/048

(52) U.S. Cl. 715/763

(57) ABSTRACT

A problem of the present invention is to provide a development tool kit for supporting development of a GUI. In order to solve the foregoing problem, a program according to the present invention is provided with a program used as a development tool kit for supporting development of an application, wherein the program is configured in such a manner that when the application associates a GUI component arranged on a display screen displayed on display unit with function information, a computer performs an association step of automatically associating a command for making an inquiry to managing unit of managing information on availability of a function specified by the function information, with the application.

### BACKGROUND OF THE INVENTION

1. Field of the Invention

The present invention relates to a program as a development tool kit for supporting application development.

2. Description of the Related Art

There is conventionally proposed a MEP (MultiFunction Peripheral) which can install or uninstall an application (Japanese Patent Laid-Open No. 2002-287990). A MFP vender has been developing hardware or an application platform operating in the hardware (OS or JAVA (registered trademark) platform operating in the OS) in such a MFP. On the other hand, a third party in alliance with the MFP vender has been developing the application operating in the application platform, as a leader.

In the MFP, functions which can be used for each user (or each group to which the users belong) are conventionally restricted in a GUI (Japanese Patent Laid-Open No. 2000-357064, Japanese Patent Laid-Open No. 2002-178567, Japanese Patent Laid-Open No. 2002-240398, Japanese Patent Laid-Open No. H10-58796 (1998)). Specially, for example, in a case where an office post of a user is low, a GUI in which a black-and-white copy may be instructed and a color copy may not be instructed is displayed on a display screen. This type device will be hereinafter explained briefly.

In a device with the GUI having the function restriction as described above, first, a user identification application makes a user input a user code or use an ID card from an operation panel, thus identifying the user. The identified result is sent to an access control unit operating in the application platform.

The access control unit operating in the application platform determines functions which should be permitted to the identified user from a table (table showing an office post of each user). For example, in a case where the post of the identified user is low, the access control unit determines that the black-and-white copy should be permitted and the color copy should not be permitted. The determined information (function restriction determining information) is transmitted to each application controlling a copying function. Here, the function restriction determining information is the information for determining whether to impose restrictions on the function of the GUI.

The application which has received the information displays on the display screen the GUI in which the black-and-white copy may be instructed and the color copy may not be instructed.

This technology has, however, the problem as shown below. For example, suppose that a third party produces the application controlling the copying function. In this case, the application is possibly designed in such a manner as to ignore the function restriction determining information transmitted from the access control unit (operating in the application platform) because of cutting down on labor hours in designing.

In this case, use of the application produced by the third party is supposed to cause the display of the GUI in which the black-and-white copy and the color copy are permitted to be made to a user however low the office post of the user is.

The present invention is made in view of the foregoing, and an object of the present invention is to provide a development tool kit for supporting development of a GUI in response to function restriction determining information transmitted from an application platform.

### SUMMARY OF THE INVENTION

In order to solve the foregoing problem, a program according to the present invention is provided with a program used as a development tool kit for supporting development of an application, wherein the program is configured in such a manner that when an application associates a GUI component arranged on a display screen displayed on display unit with function information, a computer performs an associating step of automatically associating a command for making an inquiry to managing unit for managing information on availability of a function specified by the function information, with the application.

According to the present invention, the development of the GUI in response to the function restriction determining information transmitted from the application platform is facilitated.

Further features of the present invention will become apparent from the following description of exemplary embodiments with reference to the attached drawings.

### BRIEF DESCRIPTION OF THE DRAWINGS

FIG. 1 is a schematic diagram showing a development tool kit;

FIG. 2 is a diagram showing a GUI screen of a development application;

FIG. 3 is a diagram showing function attribute values which can be set to a GUI component;

FIG. 4 is a diagram showing a setting example of function attribute values to a GUI component;

FIG. 5 is a flow chart showing an operation example of the development application in a first embodiment;

FIG. 6 is a diagram showing a drag-and-drop operation of a GUI component in a second embodiment;

FIG. 7 is a flow chart showing an operation example of a development application in the second embodiment;

FIG. 8 is a schematic diagram showing an image forming device;

FIG. 9 is a schematic diagram of software showing an application operation environment in the image forming device;

FIG. 10 is a diagram showing a user login screen displayed on a display in the image forming device;

FIG. 11 is a diagram showing an example of user information stored in the image forming device;

FIG. 12 is a diagram showing an example of function use authority information of a user stored in the image forming device;

FIG. 13 is a diagram showing an example of GUI components in an application;

FIG. 14 is a diagram showing an example of information in regard to the GUI components in the application;

FIG. 15 is a flow chart showing an operation of an image forming device in a third embodiment;

FIG. 16 is a diagram showing an example of GUI screen control in the third embodiment;

FIG. 17 is a diagram showing an example of the GUI screen control in the third embodiment;

FIG. 18 is a simplified diagram showing a network in a fourth embodiment;

FIG. 19 is a diagram showing an example of information managed by a print upper limit managing server in the fourth embodiment;

FIG. 20 is a diagram showing the relationship of FIGS. 20A and 20B;

FIG. 20A is a flow chart showing an operation of an image forming device in the fourth embodiment;

FIG. 20B is a flow chart showing an operation of an image forming device in the fourth embodiment;

FIG. 21 is a flow chart showing an operation of an image forming device in a fifth embodiment;

FIG. 22 is a flow chart showing an operation of the image forming device in the fifth embodiment;

FIG. 23 is a diagram showing an initial screen of an application in the fifth embodiment;

FIG. 24 is a diagram showing an example of an error history in the fifth embodiment;

FIG. 25 is a diagram showing a re-display screen of the application in the fifth embodiment; and

FIG. 26 is a diagram showing an example of a table used in automatically generating a source code using an API.

### DESCRIPTION OF THE EMBODIMENTS

Hereinafter, the best mode of carrying out the present invention will be explained with reference to the accompanying drawings.

### First Embodiment

Hereinafter, a first embodiment will be explained with reference to the drawings.

### (Explanation of Development Tool Kit)

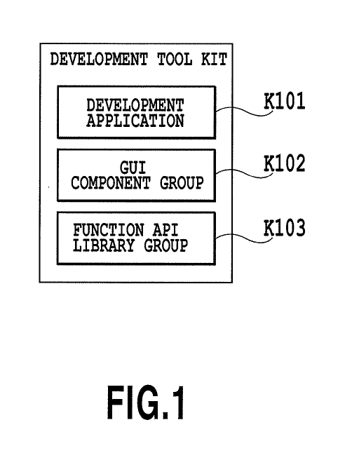

FIG. 1 is a diagram showing an outline of a development tool kit according to the present invention. The development tool kit includes a development application K101, a GUI component group K102, and a function API library K103. The development application K101 is software for development operating in a general purpose information processing device such as a usual personal computer (PC).

The development application K101 in FIG. 1 may be supplied as software operating as a single unit to a developer, but may be supplied as a general purpose plug-in of an integrated development environment. For example, the development application K101 may be supplied as a pug-in of Eclipse generally known as the integrated development environment.

The GUI component group K102 in FIG. 1 is software for displaying GUI components on a GUI operation panel in the MFP. For example, the GUI component group K102 includes a button, a radio button, a check box, a list box, a panel, a window and so on. Therefore, in the present embodiment (and in the subsequent embodiments), the GUI component shows any of the button, the radio button, the check box, the list box, the panel, and the window. It should be noted that in the present specification, the GUI component means an image displayed for receiving an instruction from a user. For example, when a user aligns a cursor with this image or touches a display position of the image (on a display), an instruction from the user can be sent to (received in) the device. Since the GUI component has the aforementioned meaning, it may be an icon or the like without mentioning. However, a main GUI component to be described later among the GUI components is the image and also has a mechanism performing various determinations or an instruction for a change. Accurately, when the CPU processes the main GUI component, it is possible to perform the aforementioned various determinations or the instruction for a change.

The function API library K103 in FIG. 1 is a software library group which provides an API for application software for the image forming device to use a function such as a software function or a hardware function of the image forming device. Here, “API” is an abbreviation of Application Program Interface.

A developer produces and compiles a GUI layout or a program code by using the development application K101, thereby producing an application which can be installed in the image forming device.

The above software K101 to K103 may be distributed to a developer through a recording medium such as CD-ROM or a download site using the Internet. The software K101 to K103 may be distributed all together or separately.

### (Explanation of Development Tool)

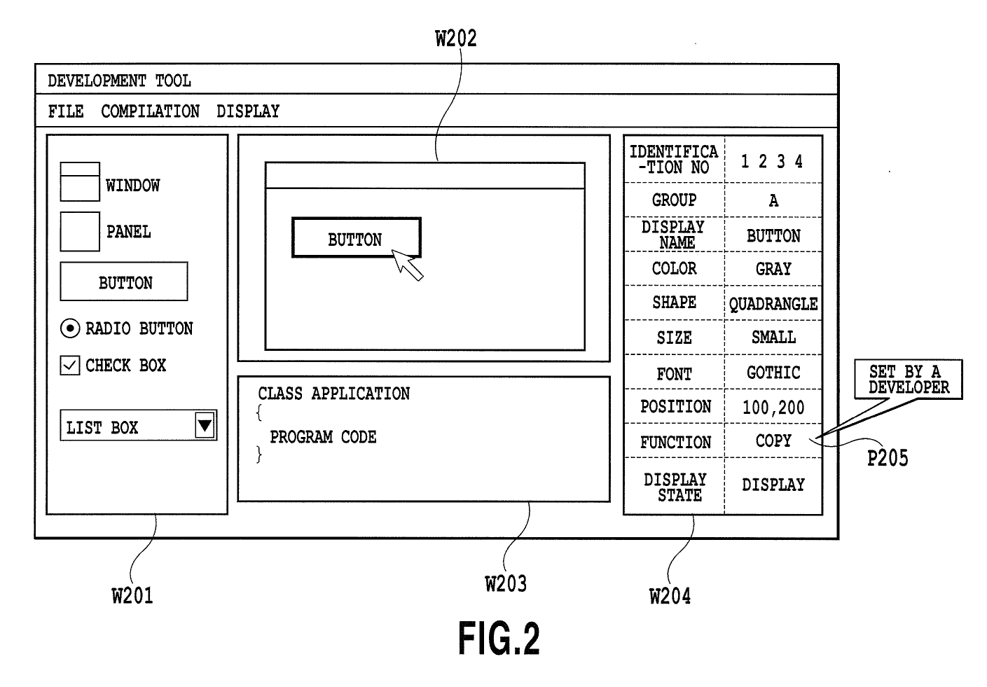

FIG. 2 is a diagram showing a display screen at the time the development application K101 in FIG. 1 is activated in a general purpose information processing device and used by a developer.

A GUI component list displaying window W201 in FIG. 2 displays a list of the GUI component group K102.

A GUI layout compiling window W202 in FIG. 2 is a screen displayed on a GUI operation panel of the image forming device. A developer compiles this screen in the general purpose information processing device, and thereby, it is possible to visually compile the GUI operation panel in the image forming device.

A source code displaying window W203 in FIG. 2 is a screen for displaying a source code automatically generated by the development application K101 and enabling a developer to directly compile the source code.

A property displaying window W204 in FIG. 2 is a window for displaying values set to an attribute of a GUI component at a selection state at the GUI layout compiling window W202. Hereinafter, the value set to the attribute is called a value of the attribute or an attribute value. The value of the attribute of the GUI component is automatically set by the GUI layout compiling window W202 or is set by a manual instruction of a developer. It should be noted that the setting of the value to the GUI component means to associate the value with the GUI component. The value of the attribute of the GUI component is not a value which the GUI component itself has, but a value associated with the GUI component. An example of the attribute of the GUI includes a function attribute, a group attribute, a display name attribute, a display color attribute, a display shape attribute of the GUI, a size attribute, a display position attribute, and a display state attribute (display, non-display, or gray-out). The display state attribute may be called a display attribute. Here, the group attribute is information for grouping GUI components, and the GUI components associated with the same attribute value show that they relate with each other by grouping. Hereinafter, a value set to the function attribute of the GUI component (attribute value) is called a function attribute value.

A function attribute item P205 points at a location displaying a function attribute value (for example, COPY) set to the function attribute in the property displaying window W204. When a user instructs a change of the function attribute value in the function attribute item P205, the development tool kit sets a new function attribute value to the function attribute in the GUI component. It should be noted that the function attribute value may be called function information. The function information is information in regard to functions of a device. For example, if the device is an image forming device, the function information includes functions such as printing, copying, scanning, and the functions of the device are specified by the function information.

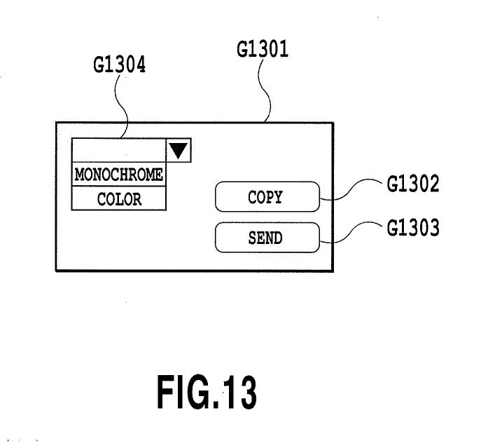

Here, at the time of pointing at a GUI component (for example, a panel G1301 in FIG. 13) in an upper position among GUI components where source codes are generated by the development application K101, the GUI component is called a main GUI component. At the time of pointing at GUI components (for example, a copy button G1302, a SEND button G1303, and a list box G1304 in FIG. 13) registered (set in such a manner as to be arranged) in the main GUI component, the GUI component is called a sub GUI component.

The sub GUT component where the source code is generated by the development application K111 is constructed as below. That is, the sub GUI component is associated with the information as below before a function attribute value is set to the function attribute of the sub GUI component. That is, the sub GUI component is associated with the information on a basis of which the main GUI component determines that the display attribute of the sub GUI component should be corrected and set from “display” to “gray-out display”, when the main GUI component managing the sub GUI component receives information of NO.

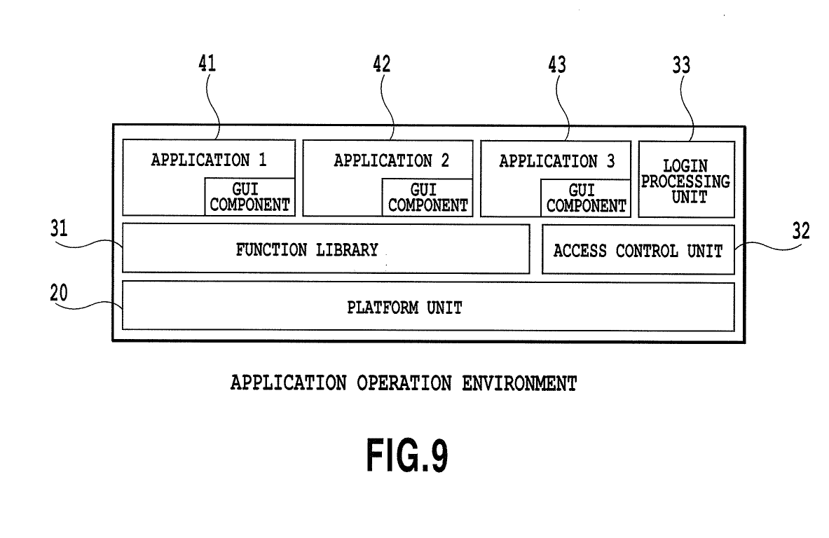

In the present embodiment, the sub GUI component can receive the information of NO in two cases as shown below. The first is a case where the response result of an API in a function library 31 in FIG. 9 to be described later is NO, that is, a case where the function specified by the function information associated with the sub GUI component does not exist in the image forming device. The second is a case where the information sent from an access control unit 32 in FIG. 9 to be described later is NO, that is, a case where use of the function specified by the function information associated with the sub GUI component is not permitted to the sub GUI component.

### (Explanation of Function Attribute of GUI Component)

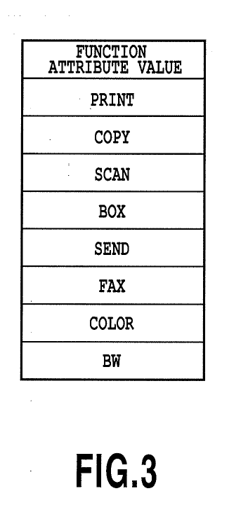

A function attribute value is set to the function attribute of a GUI component according to a selection instruction of a user out of the function attribute values defined by an image forming device vender as shown in FIG. 3, for example.

Here, for example, the function attribute values of PRINT, COPY, and SCAN each are information for specifying functions in the image forming device, such as printing, copying, and scanning.

In addition, for example, the function attribute values of BOX, SEND, and FAX each are information for specifying functions in the image forming device, such as storage of the scanned data to the hard disc, and external transmission such as electronic mail of the scanned data.

Further, for example, COLOR and BW each are information for specifying functions such as color processing and black-and-white processing to the scanned data in the image forming device.

A value independently defined as a function attribute value by a developer may be set to the function attribute.

In a case where the image forming device can not interpret the function attribute value, that value is ignored.

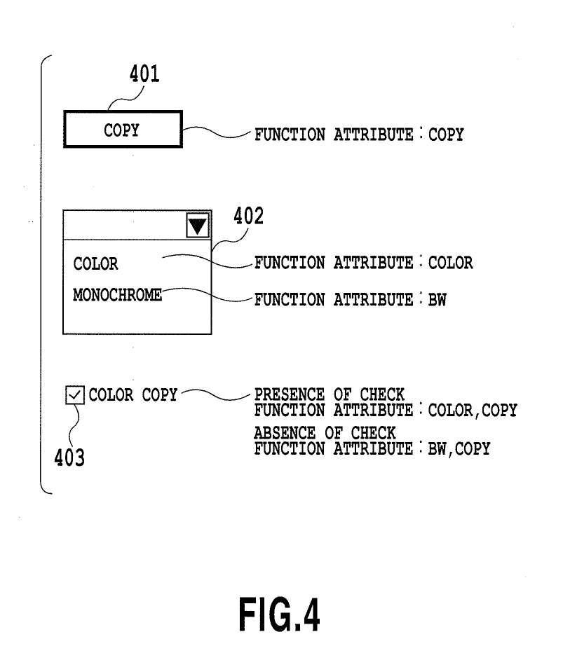

FIG. 4 is a diagram showing an example of setting a specific function attribute value to a function attribute of a GUI component.

FIG. 4 shows an example where a function attribute value COPY is set to a function attribute of a usual execution start button 401, expressing that the button 401 is a copy start button.

FIG. 4 shows an example where a function attribute value called COLOR is set to a function attribute of “color” in the list box 402, and a function attribute value called BW is set to a function attribute of “black-and-white” in the list box 402. In this case, a plurality of function attribute values are set to the function attribute of the list box 402 as one kind of the GUI component. In this way, a plurality of function attribute values may be set to the function attribute, and color copying can be expressed by setting COLOR and COPY.

FIG. 4 shows an example where the function attribute values called COLOR and COPY are set to the function attribute in a case of “presence of check” in the check box 403, and the function attribute values called BW and COPY are set to the function attribute in a case of “absence of check” in the check box 403.

As described above, a plurality of function attribute values are set as the function attribute to the GUI component expressing the selection state, such as a selection button, a list box, a check box or the like.

### (Explanation of Automatic Generation Operation of Code)

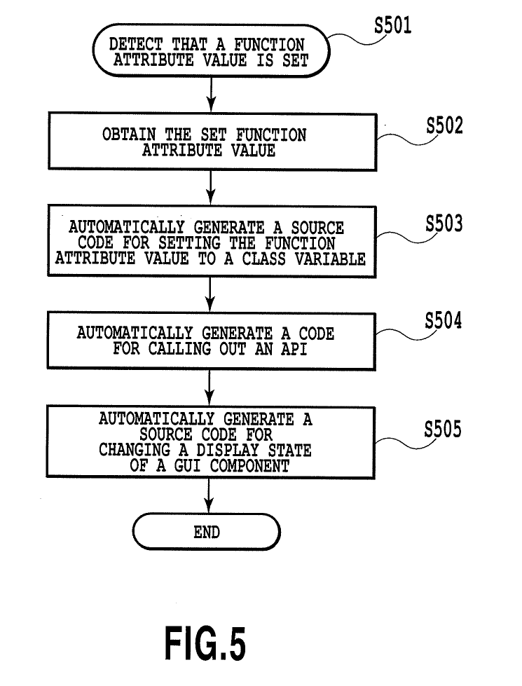

Next, an operation of the development application K101 at the time setting a function attribute value to a function attribute of a GUI component is instructed by a user in the present invention will be explained with reference to a flow chart in FIG. 5.

Here, the development application (an application is one kind of software) K101 operates by reading a command of the development application K101 with a CPU in the device in which the development application K101 is installed. Hereinafter, the development application K101 is, as an example, explained as installed in a personal computer.

First, at step S501 in FIG. 5, the development application K101 performs the following processes. That is, automatic generation of a source code is started by detecting that association of a function attribute value of a GUI component with a function attribute item P205 in the property displaying window W204 is instructed by a user (the user has input a function attribute value to the function attribute item P205). It should be noted that, after the detecting, the process automatically advances without receiving an instruction from the user until the process at step S505 is completed. In the subsequent process, the development application K101 can associate the GUI component displayed on a display with function information.

Next, at step S502, the development application K101 obtains the function attribute value which the user has instructed to be set to the GUI component.

Next, at step S503, the development application K101 automatically generates a source code for associating the function attribute value obtained at step S502 with the GUI component. Especially the development application K101 automatically generates the source code for setting the function attribute value to a class variable of the GUI component.

For example, the GUI component is expressed as a class structure in an object orientation design, and the function attribute value can be expressed as a class variable of the class. Therefore, the following source codes are generated.
ButtonClass Button 1; // generation of button class
Button 1. Name “copy”; // setting of display name of button
Button 1. Functions=“COPY”; // setting of function attribute value in function attribute of button

Next, at step S504 the development application K101 automatically generates a source code for calling out an API for inquiring availability of the function in the image forming device specified by the function attribute value in the GUI component (to the access control unit 32). The automatically generated source code is processed immediately before the GUI component is shown on a display.

Thereby, the source code at step S504 includes a command for automatically inquiring the availability of the function specified by the function information associated with the GUI component to the access control unit 32 managing the availability of the function.

At step S504, the development application K101 associates the source code in relation to step S504 with the GUI component.

Here, the GUI component may be a GUI component arranged on a display screen which the application in the middle of being developed at the development application K101 displays on a display. In this case, the application in the middle of being developed at the development application K101 is associated with the source code at step S504.

It should be noted that in the above explanation, the image forming device is described as an example, but in the present embodiment, the development application does not operate in the image forming device, but operates in a personal computer. Therefore, here, the image forming device means a device where the source code produced through the present development application is installed.

Next, at step S505, the development application K101 automatically produces a source code changing a display state of the GUI component in accordance to the response result of the inquiry about the availability. The API for inquiring the availability of the function is provided from the aforementioned function API library K103.

That is, the source code at step S505 includes a command for determining the display state of the GUI component in accordance with the response result to the inquiry “to the access control unit 32 managing the information of the availability of the function specified by the function attribute value of the GUI component”. This source code describes that in a case where the main GUI component managing the sub GUI component receives information of NO, the main GUI component should determine to correct and set the display attribute of the sub GUI component from “display” to “gray-out display”. That is, such a main GUI component is so constructed in the source code as to make the above determination in the above case.

At step S505, the development application K101 automatically associates the source code at step S505 with the GUI component.

Here, the GUI component may be a GUI component arranged on the display screen which the application in the middle of being developed at the development application K101 displays on the display. In this case, the application in the middle of being developed at the development application K101 is associated with the source code at the step S505.

For example, there is provided a general purpose API for requesting a determination by providing a class itself or a function attribute value of a GUI component as in the following API examples (1) and (2) or an API prepared in each function as in the following API example (3).

For example, in a case of automatically generating a source code using the API as in the API example (3), a table associating the function attribute value with the API corresponding to the function attribute value is provided in the development tool kit. The development application K101 refers to the above table, and can associate the API for inquiring about availability of the function with the GUI component based upon the function attribute value set to the GUI component.

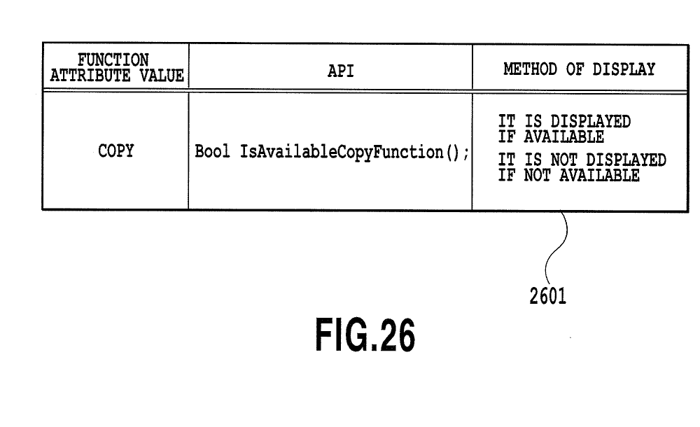

FIG. 26 shows a table 2601 to be referred to at the time the development application K101 automatically generates a source code example (3) to be described later. The table 2601 includes information about the method of displaying the GUI component.

The development application K101, at the time of referring to the table 2601, may obtain information of a class of the GUI component (for example, “button”) from the GUI component list displaying window W201. In addition, the development application K101, at the time of referring to the table 2601, may obtain information of a display name of the GUI component (for example, “copy”) from the property displaying window W204.

### API EXAMPLE (1)

Void IsAvailableFunction (GUI component class); API determines availability from the function attribute set to the GUI component and sets a display state of the GUI component.

### API EXAMPLE (2)

Bool IsAvailableFunction (function attribute value); API provides the function attribute value and answers about the availability.
Bool IsAvailableCopyFunction( ); API answers about the availability of a copying function.

The source code automatically generated using the above API is as follows, for example. The following source code examples (2) and (3) show to change the display state of the GUI component based upon the response result from the API. The API of the API example (1) is designed to include functions of both availability determination on the function and display state changing processing of the GUI component.

### SOURCE CODE EXAMPLE (1)

ButtonClass Button 1; // generation of button class
Button 1. Name=“copy”; // setting of display name of button
Button 1. Functions=“COPY”; // setting of function attribute value of function attribute of button
IsAvailableFunction (Button 1); A display state is set on top of determining availability of the GUI component.

### SOURCE CODE EXAMPLE (2)

ButtonClass Button 1; // generation of button class
Button 1. Name=“copy”; // setting of display name of button
Button 1. Functions=“COPY”; // setting of function attribute value of function attribute of button
Bool bRESULT=IsAvailableFunction (Button 1.Function); // inquiry about the availability of the function.
If (bresult==TRUE) {Button 1.Visible=TRUE; display if available}else{Button 1.Visible=FALSE; do not display if not available}

### SOURCE CODE EXAMPLE (3)

ButtonClass Button 1; // generation of button class
Button 1. Name=“copy”; // setting of display name of button
Button 1. Functions=“COPY”; // setting of function attribute value of function attribute of button
Bool bRESULT=IsAvailableCopyFunction( ); // inquiry about the availability of the copying function.
If (bResult==TRUE) {Button 1.Eable=TRUE; display if available}else{Button 1.Eable=FALSE; gray-out is set to display if not available}
The above source code is simply one example, and the source code may adopt any source code if the code is a command or a set of commands executable by a computer determining the processing identical to the processing of the computer executed by the above source code.

There is a case where the GUI component receives the response result of the inquiry about the availability one time or plural times asynchronously, and each time the GUI component receives the response result, the display state of the GUI component is once more changed in accordance with the response result, thus once more drawing the screen. In this case, since it is required for the GUI component to receive the response result asynchronously, a source code registering a function for receiving the response result using a function-registering API in the function API library is generated. A specific operation of the source code at application operating will be described in a fourth embodiment to be described later.

### Second Embodiment

Hereinafter, a second embodiment will be explained with the drawings.

The first embodiment shows an embodiment where the developer sets the function attribute value of the function attribute to each GUI component of the GUI component group K102 provided by the development tool kit. The second embodiment shows an embodiment where GUI components provided by the development tool kit are in advance produced for use purpose and a program is incorporated in each GUI component for inquiring about availability of each function to the image forming device.

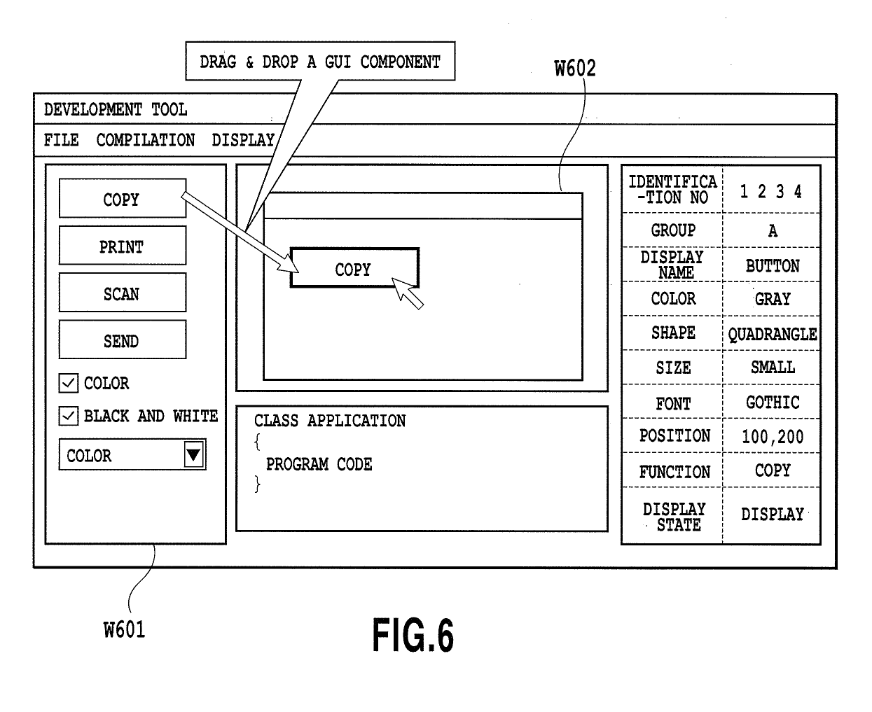

FIG. 6 shows an activation screen of the development application K101. For example, a button for copying, a button for printing, a button for scanning, a button for external transmission of scan data, a check box for selecting color or black-and-white, a list box and the like are displayed at the GUI component list displaying window W601. These GUI components are provided from the GUI component group K102 of the development tool kit and loaded to the development application K101 for the displaying.

A set of function information and a program for calling out an API as a command for inquiring about availability of each function contained in the function information is incorporated in these GUI components. For example, a part of the source code examples shown in the first embodiment is incorporated in the display processing program of the GUI component.

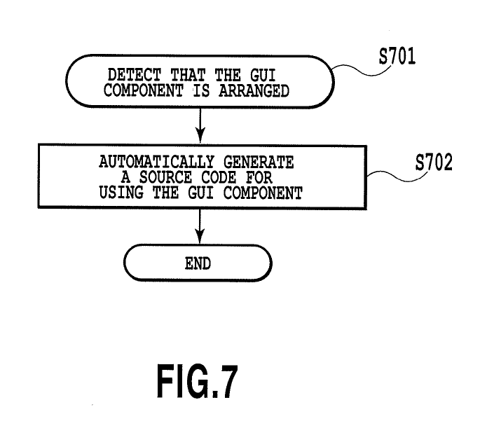

Next, an operation of the development application K101 in the second embodiment will be explained with reference to a flow chart in FIG. 7.

First, at step S701, the development application K101 detects that a GUI component is arranged on a display screen for display with the developing application at the development application K101.

Specifically, for example, the development application K101 detects that the GUI component is dragged and dropped from the GUI component list displaying window W601 to be arranged at the GUI layout compiling window W602 by a developer.

Next, at step S702, the development application K101 automatically generates a source code for an application for the image forming device to use the GUI component.

Here, the source code at step S702 is software for executing a command for inquiring about availability of the function specified by the function information associated with the GUI component detected at step S701 to the access control unit 32.

At step S702, the development application K101 automatically associates the software at step S702 with the GUI component.

For example, the development application K101 generates the following source codes.
CopyButton CopyButton 1; // generation of copying button
CopyButton 1. Update( ); // display execution of button

The above source code is simply one example, and the source code may adopt any source code if the source code is a command or a set of commands executable by a computer determining the processing identical to the processing of the computer executed by the above source code.

The above source code generates an instance of a class for button having the function inquiring about availability of the copying function. The availability of the function and the inquiry or the changing processing of the display state of the GUI component in accordance with the response result of the availability as shown in the first embodiment are performed as the internal process of copybutton. Updata( ).

In the first and second embodiments, as one example of the GUI component, the process for generating the source code of the button is explained, but the process for generating the source code of the GUI component such as the panel or the list box is also performed by the same process as one shown in the first and second embodiments.

Further, the software K101 to K103 according to the first and second embodiments can produce the source code defining a mutual relation of the GUI component group. For example, the software K101 to K103 according to the first and second embodiments can produce the source code that a button is arranged on the panel.

### Third Embodiment

Hereinafter, a third embodiment will be explained with reference to the drawings.

an embodiment in an image forming device in which a GUI component display is performed in accordance with use authority in regard to functions of a user in the present invention will be explained as follows.

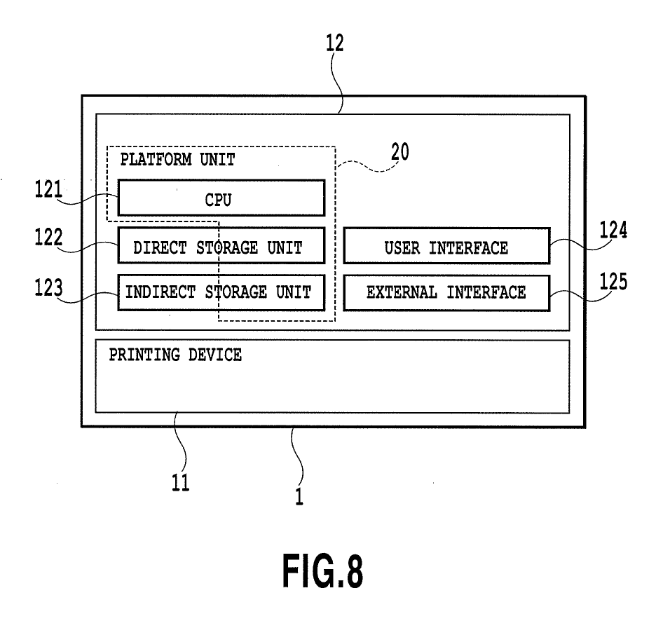

FIG. 8 is a block diagram showing an outline of an image forming device to which an application platform in the present invention is applied.

### (Explanation of Image Forming Device)

As shown in FIG. 8, the image forming device 1 is constructed of a printing device 11 and an image processing device 12.

The image processing device 12 includes a CPU 121, a direct storage unit 122 (for example, RAM), an indirect storage unit 123 (for example, ROM or HDD), a user interface 124, and an external interface 125.

The direct storage unit 122 is a storage unit for directly transmitting data to or receiving data from the CPU 121, and the indirect storage unit 123 is a storage unit for transmitting data to or receiving data from the CPU 121 through the direct storage unit 122. Various types of application programs and platform programs are stored in the direct storage unit 122.

The user interface 124 is constructed of, for example, a key board, a mouse, and a display, and is configured to receive an instruction from a user to display data (screen data).

The external interface 125 is configured to be capable of receiving data from an external device and transmitting data to the external device. For example, the external device includes an external storage device such as an external HDD or an external USB memory and a separate device such as a separate host computer (personal computer) connected through a network or the image forming device 1.

### (Explanation of Platform Unit 20)

The CPU 121 can move (store) the platform program stored in the indirect storage unit 123 to the direct storage unit 122. When the movement is completed, the CPU 121 becomes in a state of being capable of performing the platform program. In the present embodiment, an event that “the CPU 121 thus becomes in a state of being capable of performing the platform program” is called an event that the platform unit 20 is activated.

In the present embodiment, a combination of the following three devices is called the platform unit 20. The combination is composed of the CPU 121, the device for storing the platform program in the direct storage unit 122, and the device (in the direct storage unit 122 and the indirect storage unit 123) for storing the information (for example, calculation result) obtained at the time the CPU 121 processes the platform program.

### (Explanation of Application Program)

The platform unit 20 can move (store) a first application program and a program group necessary for application execution which are stored in the indirect storage unit 123 to the direct storage unit 122. When the movement is completed, the platform unit 20 becomes in a state of being capable of performing the first application program. In the present embodiment, this state is called an event that the platform unit 20 activates the first application program.

Conversely, the platform unit 20 can eliminate the first application program stored in the direct storage unit 122 from the direct storage unit 122. In the present embodiment, this process is called an event that the platform unit 20 stops the first application program.

The platform unit 20 can receive and store data as the first application program through the external interface 125. In the present embodiment, this process is called an event of installing the first application program in the platform unit 20.

Conversely, the platform unit 20 can eliminate the first application stored in the indirect storage unit 123 (inside the platform unit 20) from the indirect storage unit 123. In the present embodiment, this process is called an event that the platform unit 20 uninstalls the first application.

In a case where the first application is activating at the time the platform unit 20 uninstalls the first application, the first application is uninstalled after stopping the activation of the first application.

The explanation as described above is made taking the first application program as an example, but it should be understood that it is apparent for persons skilled in the art that the other application (for example, a second application program) can be processed in the same way as the first application.

FIG. 9 is a diagram showing applications activating in the platform unit 20 in the image forming device 1 and an operation environment of the application.

A function library 31 in FIG. 9 is a program for an application to call out a software function and a hardware function in the image forming device.

The access control unit 32 in FIG. 9 refers to information and a function use authority of a user logging into the image forming device to determine whether or not the user in the middle of logging in can use functions in various image forming devices.

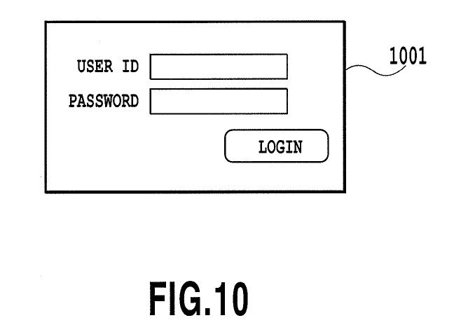

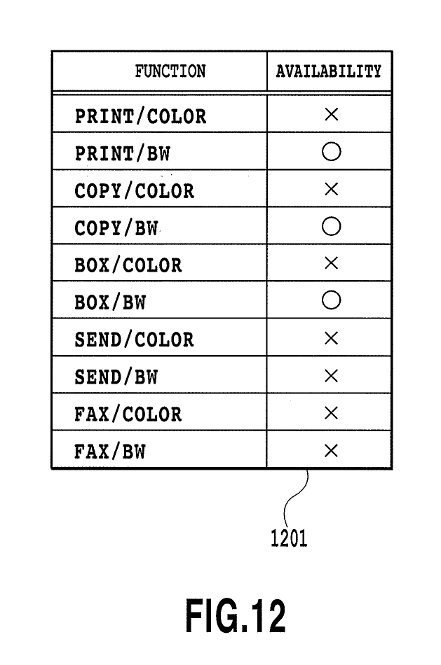

A login processing unit 33 in FIG. 9 displays a login screen (screen 1001 in FIG. 10) on a display to which account certification information of a user can be input, and performs user certification processing by receiving an input operation from the user. Further, the login processing unit 33 obtains function use authority information (table 1201 in FIG. 12) to the certified user through the indirect storage unit 123 or the external interface 125 and stores the function use authority information in the direct storage unit 122.

In FIG. 9, an application 1 (41), an application 2 (42), and an application 3 (44) are applications activating in the image forming device and respectively include GUI components for display on a display.

For example, the source codes realizing the GUI components in the first and second embodiments can be installed as operated as the applications 1 to 3 (41 to 43) activating in the platform init 20.

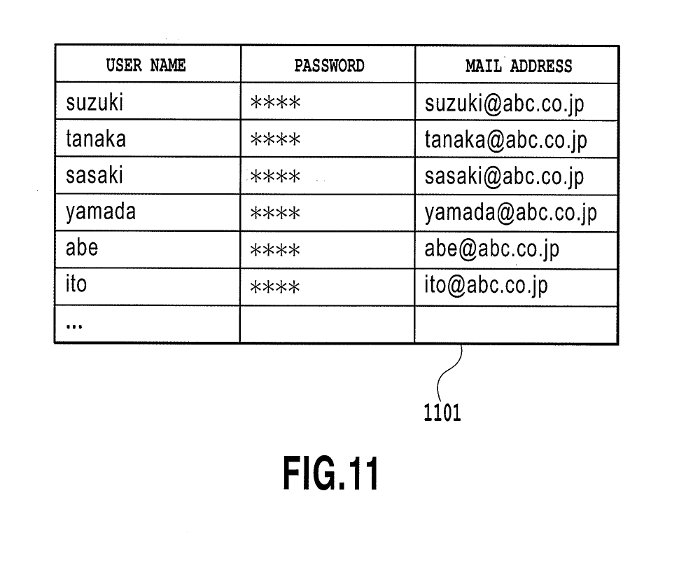

FIG. 11 is a diagram showing a management table 1101 of a user who logs into the image forming device 1. User's information is recorded in the management table 1101.

The management table 1101 is stored in the indirect storage unit 123 or the external device.

FIG. 12 is a diagram showing function use authority information of a user to the functions contained in the image forming device. The use authority of the user contained in the function use authority information (table 1201) in FIG. 12 differs in each user and is made associated with each of users registered in the user's management table 1101, which is stored in the indirect storage unit 123 or the external device. For example, the table 1201 in FIG. 12 shows that print, copy, and box in black-and-white (store scan data into an internal storage device and obtain it) are permitted. In addition, the table 1201 in FIG. 12 shows that print, copy, and box in color are prohibited, and SEND (scan data transmission to an outside) and FAX are also prohibited.

That is, the functions usable for a user are specified by the function use authority information in the table 1201 in FIG. 12. It should be noted that the function use authority information shown in FIG. 12 is simply one example and may include the number of the usable times. Here, the number of the usable times means the number of times by which a user can use the function.

FIG. 13 is a diagram showing a layout example of a GUI in an application. Here, a panel G1301, a copy button G1302, a SEND button G1303, and a list box G1304 are GUI components. The copy button G1302, the SEND button G1303, and the list box G1304 are arranged on the panel G1301.

Here, the panel G1301 (main GUI component) operates by reading a command expressing the panel G1301 with the CPU in the device in which the source code expressing the panel G1301 is installed. Hereinafter, the source code realizing the panel G1301 will be explained as installed in a personal computer connected to the image forming device 1, as an example.

The panel G1301 and the GUI components arranged on the panel G1301 have a dependent relationship, and can be expressed with the following codes as source codes.

The following source codes are generated by the software K101 to K103 according to the first and second embodiments.

First, the software K101 to K103 according to the first and second embodiments generate the panel G1301 called panelG1301 and the copy button G1302 called copy ButtoG1302. Further, the software K101 to K103 according to the first and second embodiments generate the SEND button 1303 called sendButtonG1303 and the list box G1304 called listBoxG1304.

Here, the names of the buttons G1302 and G1303 may be defined by identification numbers of the property displaying window W204 of the display screen in FIG. 2. For example, when the identification number is “G1302” and the function is “COPY” in the property displaying window W204 on the display screen in FIG. 2, the name of the button may be defined as “copyButtonG1302” by the software K101 to K103 according to the first and second embodiments.

Here, in the same way as the names of the buttons G1302 and G1303, the name of the panel G1301 may be defined by the identification number of the property displaying window W204 of the display screen in FIG. 2. For example, when the identification number is “G1301” and the function is “PANEL” in the property displaying window W204 on the display screen in FIG. 2, the name of the button may be defined as “panelG1301” by the software K101 to K103 according to the first and second embodiments.

The software K101 to K103 according to the first and second embodiments can produce source codes defining a relation between the buttons G1302 and G1303, the list box G1304, and the panel G1301. For example, the software K101 to K103 according to the first and second embodiments can produce a source code for arranging the buttons G1302, G1303 and the list box G1304 on the panel G1301.

The following source codes are generated by the source codes of the GUI components G1302 to G1304 and the source code for arranging the GUI components G1302 to G1304 on the panel G1301 which are generated at the software K101 to K103 according to the first and second embodiments.
Panel panelG1301; // meaning of generating the panel G1301
Panel.Add (copyButtonG1302); // register the copy button G1302 (meaning of arranging the copy button G1302 on the generated panel)
Panel.Add (sendButtonG1303); // register the SEND button G1303
Panel.Add (listBoxG1304); // register the list box G1304

The above source code is simply one example, and the source code may adopt any source code if the source code is a command or a set of commands executable by a computer determining the processing identical to the processing of the computer executed by the above source code.

Hereinafter, as described in the explanation of the first and second embodiments, at the time of pointing at a GUI component (for example, a panel G1301) in an upper position, the GUI component is called a main GUI component. At the time of pointing at GUI components (for example, a copy button G1302, a SEND button G1303, and a list box G1304) registered (set in such a manner as to be arranged) in the main GUI component, the GUI component is called a sub GUI component.

The main GUI component calls out an API contained in the sub GUI component, thereby making it possible to obtain or change a state of the sub GUI component. The sub GUI component can notify the change of the state (for example, pushdown of a button or a change of the selection state) or the like by calling out an API contained in the main GUI component. The application calls out the API in the main GUI component in the application. An operation of calling out the API in the main GUI component is called an event that the GUI component detects a display demand from the application. It should be noted that it is not the entire application, but a module receiving “an instruction of a display demand to a display” among the application from an outside that calls out the API in the main GUI component. That is, it is a module “which is called out from the platform unit 20 and promotes screen display processing to a display”. Hereinafter, this module is called the application as it is.

When the main GUI component detects the display demand, the main GUI component performs also the display process of the sub GUI component together with the main GUI component. Therefore, the application is required to request the display demand only to the main GUI component and is not required to request the display demand to the individual sub GUI components. The main GUI component uses the function attribute value obtained from the sub GUI component to call out the API of the function library, making it possible to inquire about availability of the sub GUI component group. In the following explanation, this process is called simply an event that the main GUI component inquires about availability of the sub GUI component.

The main GUI component is so constructed as to correct and set a value of the display attribute of the sub GUI component when the main GUI component receives the information of NO. In the present embodiment, even if the value of the display attribute in the sub GUI component is set as display, when the main GUI component receives the information of NO, the main GUI component corrects and sets (changes) the value of the display attribute in the sub GUI component to, for example, gray-out. In the present embodiment, in the following two cases the main GUI component can receive the information of NO.

The first is a case where the response result of the API in the function library 31 in FIG. 9 is NO and use of the sub GUI component is not permitted. The second is a case where use at the access control unit 32 in FIG. 9 is NO and use of the sub GUI component is not permitted.

in the following explanation, the panel G1301 is interpreted as the main GUI component, and the copy button G1302, the SEND button G1303 and the list box G1304 are interpreted as the sub GUI components.

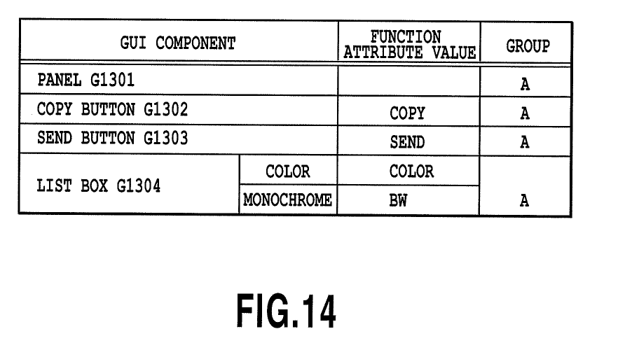

As shown in FIG. 14, in regard to the function attribute values, COPY is set to the copy button G1302, SEND is set to the SEND button G1303, COLOR is set at the time of selecting “color” in the list box G1304 and BW is set at the time of selecting “monochrome” in the list box G1304. These function attribute values are thought to be in advance set at the time of application production by using the development tool kit in the first embodiment or in the second embodiment. However, the application may dynamically rewrite these function attribute values.

Further, the copy button G1302, the SEND button G1303, and the list box G1304 are associated with each other by grouping. In a case where the copy button G1302 is pushed down at the time of selecting “color” in the list box G1304, the color copy is performed.

In a case where the copy button G1302 is pushed down at the time of selecting “monochrome”, the black-and-whiter copy is performed. In a case where the SEND button G1303 is pushed down at the time of selecting “color” in the list box G1304, external transmission of the scanned color image data is performed. On the other hand, in a case where the SEND button G1303 is pushed down at the time of selecting “monochrome”, external transmission of the scanned black-and-white image data is performed.

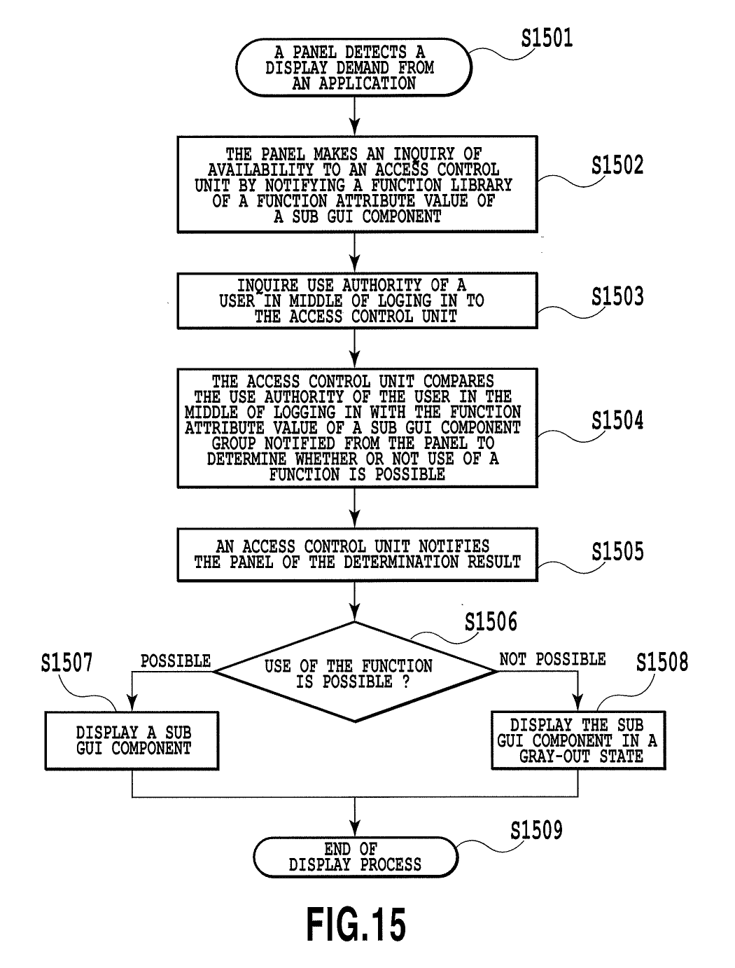

Next, by taking a GUI of an application in FIG. 13 as an example and referring to a flow chart in FIG. 15, an operation at the displaying of a GUI screen of an application using GUI components according to the present invention will be explained.

It is assumed that a user logs into the image forming device before displaying the GUI screen of the application, and the information and the function use authority information (table 1201 in FIG. 12) of the certified user in the middle of logging in are stored in the direct storage unit 122.

Specially a user inputs user information on a login screen such as a screen 1001 in FIG. 10 shown by a login processing unit 33, thereby performing a login operation to the image forming device.

Here, the user information may contain a user ID such as a user name or a password.

The login processing unit 33 in FIG. 9 detects a login operation of a user, obtains the input user information, and compares the user information with the management table 1101 recorded in the indirect storage unit 123 in the image forming device, thereby performing certification processing of the user.

In a case where the user is a certified user, the user information and the function use authority information (table 1201 in FIG. 12) associated with the user information are further read out from the indirect storage unit 123 to the direct storage unit 122. The user information and the function use authority of a user stored in the direct storage unit 122 can be referred to by the applications 1 (41), 2 (42), and 3 (43) or by the access control unit 32.

The login processing unit 33 notifies the platform unit 20 of completion of the login processing. When the platform unit 20 receives a notification of the completion of the login processing, the platform unit 20 promotes the applications 1 (41), 2 (42), and 3 (43) to perform screen display processing to the display. The applications 1 (41), 2 (42), and 3 (43) called out from the platform unit 20 make a display demand to the main GUI component.

As shown in FIG. 15, first, at step S1501 the panel G1301 as the main GUI component detects the display demand from the application to receive a command for displaying the GUI component on a display, thereby starting an operation.

Here, the panel G1301 is the main GUI component, and can obtain the function information associated with the sub GUI component in the main GUI component any time.

Next, at step S1502, the panel G1301 obtains the function attribute values of the GUI components (copy button G1302, SEND button G1303, and list box G1304) on the panel. The panel G1301 notifies the access control unit 32 through the API in the function library 31 of the obtained function attribute values, thereby inquiring about availability of each function specified by the function information associated with the sub GUI.

At this time, the panel G1301 combines (sums) the function attribute values set to the sub GUI components. For example, the panel G1301 generates, as the combined (summed) function attribute values, color copy (COPY/COLOR), black-and-white copy (COPY/BW), external transmission of color image data (SEND/COLOR), and external transmission of black-and-white data (SEND/BW).

Next, ate step S1503, the panel G1301 inquires about availability of the function specified by the function information associated with the sub GUI component of a user in the middle of logging in to the access control unit 32.

As described above, the panel G1301 inquires about availability of the function specified by the function information associated with the sub GUI component to the access control unit 32 by using the information obtained by summing the function attribute values of the sub GUI components.

Next, at step S1504, the access control unit 32 inquired obtains the function use authority information (table 1201 of FIG. 12) of the sub GUI component of the user in the middle of logging in from the direct storage unit 122. That is, at step S1504, the access control unit 32 obtains the function restriction information associated with the user information.

The access control unit 32 compares the function attribute value notified from the panel G1301 with the table 1201 to determine whether or not use in the function of the sub GUI component is possible (YES (possible) or NO (not possible)). That is, the access control unit 32 determines that the use of the function is possible in a case where the function attribute value notified from the panel G1301 is determined to be usable in the table 1201 based upon a corresponding relation between the function attribute value notified from the panel G1301 and the table 1201. On the other hand, the access control unit 32 determines that the use of the function is not possible in a case where the function attribute value notified from the panel G1301 is determined to be not usable in the table 1201 based upon the corresponding relation between the function attribute value notified from the panel G1301 and the table 1201.

For example, in a case where at the list box G1304 in FIG. 13, “color” is selected and the copy button G1302 is pushed down, the function attribute value is “color copy (COPY/COLOR)”. In consequence, by referring to the table 1201 in FIG. 12, it is determined that use of the “color copy (COPY/COLOR)” function is not possible (NO).

Next, at step S1505, the access control unit 32 notifies the panel G1301 of the determination result (YES (possible) or NO (not possible)).

Next, at step S1506, the panel G1301 refers to the determination result (YES (possible) or NO (not possible)) notified at step S1505 to determine whether or not use of the function of the sub GUI component is possible (YES (possible) or NO (not possible)). In a case where the determination result is YES (possible), use of the function is YES (possible). In a case where determination result is NO (not possible), use of the function is NO (not possible).

In a case where it is determined at step S1506 that the information of YES (possible) has received, the process goes to step S1507, wherein the panel G1301 displays the sub GUI component on the panel G1301 without changing the display attribute value. The process goes to step S1509.

On the other hand, in a case where it is determined at step S1506 that the information of NO has received, the process goes to step S1508, wherein the panel G1301 determines that the sub GUI component becomes in a given display state at the panel G1301. In addition, the panel G1301 performs the display based upon the determination (for example, non-display or gray-out display). The process goes to step S1509. The given display state means a state for making a user not select the sub GUI component (or a part of the sub GUI component) as in the case of non-display or gray-out display, for example. Here, for example, in a case where the sub GUI component is a list box, a part of the sub GUI component may be made to the non-display for making the user not select the part of the sub GUI component. Further, in a case where the sub GUI component is a GUI component receiving check, a portion of the sub GUI component receiving the check may be made to the non-display for making the user not select a part of the sub GUI component.

At step S1508, the panel G1301 determines that in the table 1201 in FIG. 12, the attribute (value of the display attribute) expressing a display state of the SEND button not usable regardless of color or black-and-white is corrected and set to gray-out, and the panel G1301 corrects and sets the display state to the gray-out. The panel G1301 displays the SEND button in a state of gray-out on the panel G1301. It should be noted that the panel G1301 is in advance being displayed on the display as described above.

Here, based upon the content of the table 1201, for example, there may be a case where both of the list box G1304 and the SEND button G1303 on the panel G1301 are displayed in a gray-out state. In addition, based upon the content of the table 1201, for example, there may be a case where among the list box G1304 on the panel G1301, “color” alone is displayed in a gray-out state and the SEND button G1303 is not displayed in a gray-out state (displayed in a usual state).

The processes of steps S1506 to S1508 cause the GUI component in the display state in accordance with the response result to the inquiry to the access control unit 32 according to step S1502 to be controlled to be displayed on the display.

At step S1509, the display process ends.

By the process in FIG. 15, in a case where there exist a plurality of GUI components associated with the function information, a display state of the GUI component is determined in accordance with the response result from the access control unit 32 managing the information in regard to availability of the function specified by the function information.

Further, in a case where there exist a plurality of GUI components associated with the function information, when a display state of the GUI component changes, a display state of the other GUI component relating to the GUI component may be determined in accordance with the information in regard to the availability of the function specified by the function information.

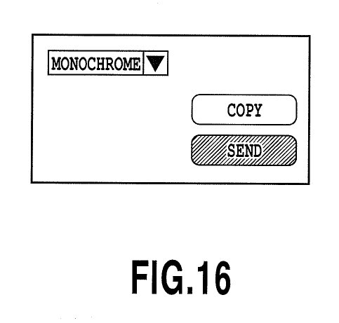

FIG. 16 shows an example of a GUI at an initial display time displayed based upon function use authority information (a table 1201 in FIG. 12) of a user in the middle of logging in.

After displaying the GUI of the application, when a change of the display state of the GUI is detected, the GUI component once more determines availability of the function and once more updates the display state of the GUI component.

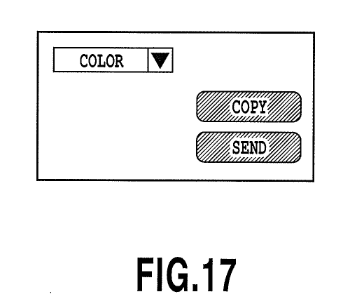

For example, in a case where a color copy (COPY/COLOR) is prohibited in a state in FIG. 16, when the panel G1301 detects that a user has changed a selection state of the list box G1304 from “monochrome” to “color”, the following process is performed. That is, the panel G1301, as shown in FIG. 17, sets the attribute expressing the display state of the copy button G1302 to a gray-out state for prohibiting a color copy (COPY/COLOR).

At this time, the panel G1301 may use the determination result of the availability of the color copy (COPY/COLOR) obtained at an initial display time or may once more inquire to the access control unit 32. The control of in advance setting a display state of “color” of the list box G1304 to a gray-out state or non-display state at an initial display time is possible so that the user can not select “color” of the list box G1304 which can not be used regardless of copy or SEND.

### Fourth Embodiment

Hereinafter, a fourth embodiment will be explained with reference to the drawings.

The following embodiment is to shorten time of inquiring about availability of a function of a GUI component through a network in a case where there exist a plurality of managing unit for managing the information in regard to availability of a function in the image forming device. For solving the above problem, the present embodiment quickly performs a display of a GUI component using the determination history of the past function availability (availability determination history) of the GUI component stored in the image forming device.

In the present embodiment, in the same way as in the third embodiment, the source codes realizing the GUI components in the first and second embodiments can be installed as operating as the applications 1 to 3 (41 to 43) activating in the platform unit 20.

It should be noted that also in the present embodiment, in the same way as in the first to third embodiments, the function of the GUI component is specified by the function information.

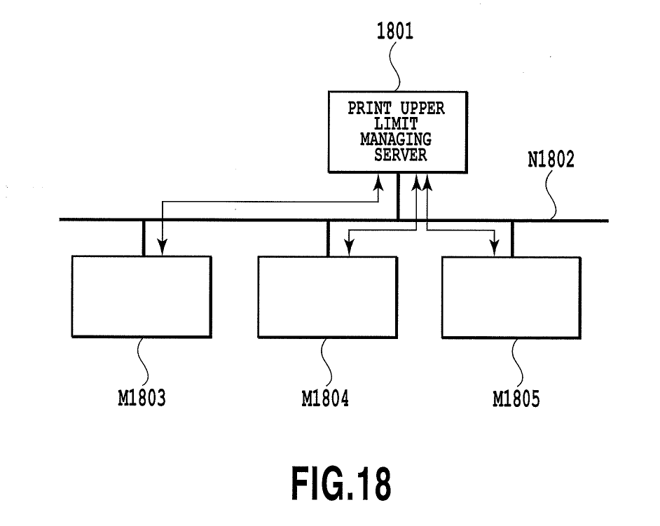

FIG. 18 is a diagram showing a network in the present embodiment.

As shown in FIG. 18, a print upper limit managing server 1801 is connected through a network N1802 to a plurality of image forming devices M1803, M1804, and M1805, and can communicate with each other.

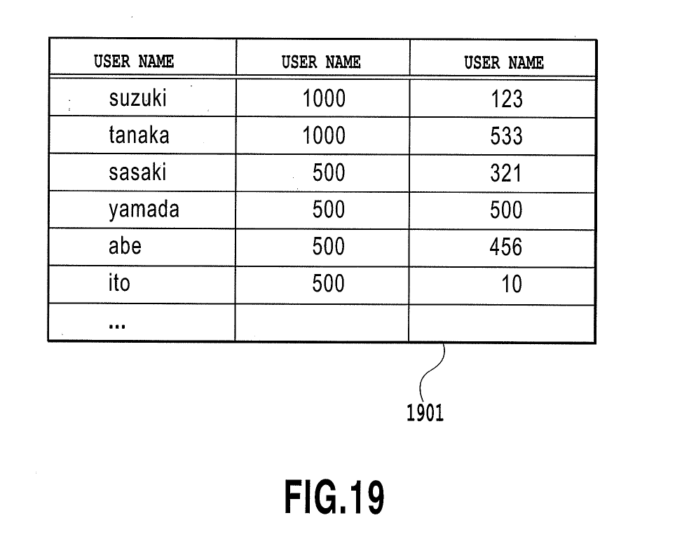

The print upper limit managing server 1801 in FIG. 18 manages users, a print upper limit (an upper limit value of the numbers of sheets printable by each user), and a print result (the numbers of sheets printed actually) in the image forming device by using a table 1901 in FIG. 19.

Each of the image forming devices M1803, M1804, and M1805 in FIG. 18 has a function of notifying the print upper limit managing server 1801 of the numbers of sheets used for a user's print. Further, the print upper limit managing server 1801 receives an inquiry about availability of print by a user in the middle of logging in from the image forming device and compares the print upper limit of the user with the print result to determine the availability of the print, making a reply of the result. In a case where the print result reaches the print upper limit, the print upper limit managing server 1801 determines that use of the print is not permitted.

The image forming devices M1803 to M1805 according to the fourth embodiment are the same as in the image forming device 1 according to the third embodiment. The image forming devices M1803 to M1805 store the management table 1101 of users and the function use authority information of each user (table 1201 in FIG. 12) in the indirect storage unit 123 in the image forming device in addition to the above print upper limit and the print result information. The image forming devices M1803 to M1805 manage the function use authority of each user in the access control unit 32.

The access control unit 32 of one image forming device out of a plurality of the image forming devices M1803 to M1805 refers to the function use authority information (table 1201 in FIG. 12) of a user in the middle of logging in in a case of receiving an inquiry of availability of a print function or a copy function. The access control unit 32 further makes an inquiry about availability of the print to the print upper limit managing server 1801 through the external interface 125. It is determined that the availability of a final print function or copy function exists only in a case where both of the function use authority of the GUI component of a user in the middle of logging in and the response result in the inquiry to the print upper limit managing server show “available”.

That is, in the fourth embodiment, the availability of the print function or the copy function can be determined by the function use authority information of the GUI component of a user in the middle of logging in stored in the direct storage unit 122 without receiving the result of the inquiry to the print upper limit managing server through the network N1802.

Further, the determination result is stored in the indirect storage unit 123 as the availability determination history for each user and is used for determination on a temporary function availability. The availability determination history is stored also after a user logs out and is used also at the time the same user once more logs in.

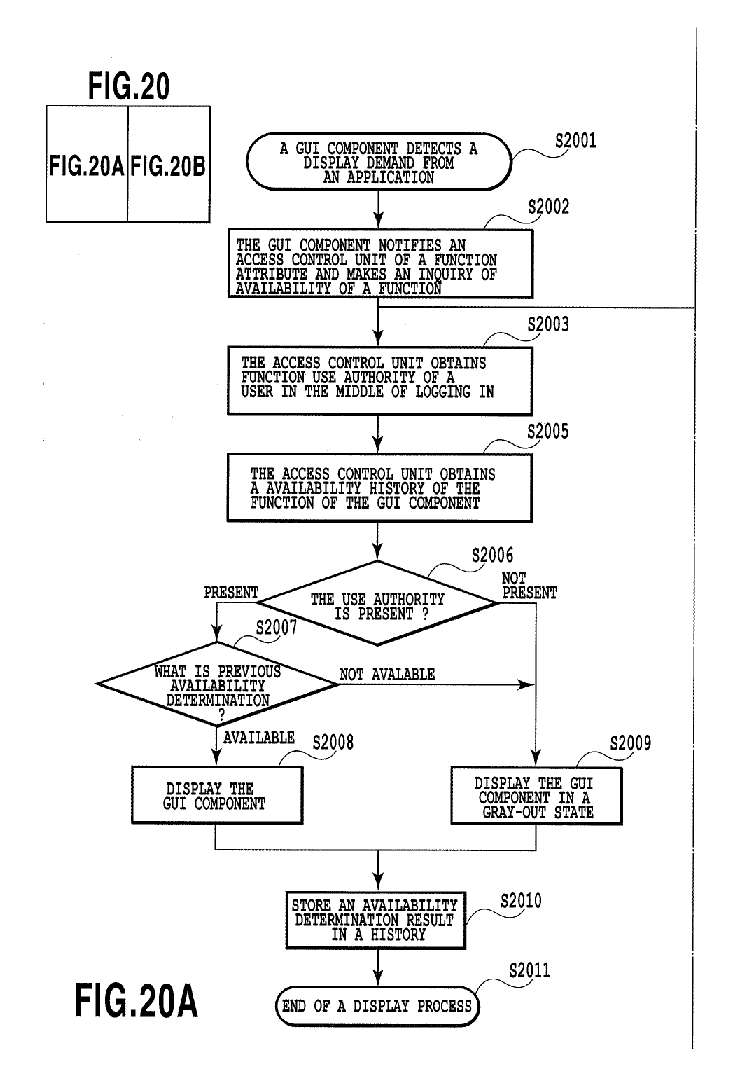

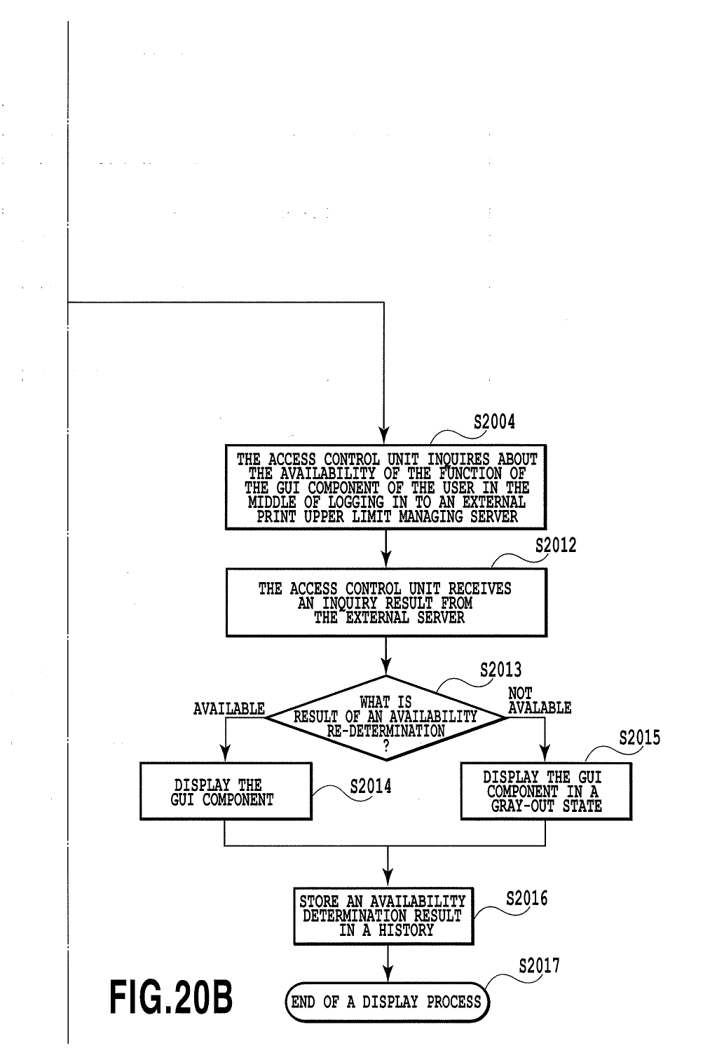

A display operation of the GUI component (for example, copy button) in the present embodiment will be explained with reference to a flow chart in FIG. 20.

First, at step S2001 in FIG. 20, the GUI component starts with the display operation by detecting a display demand from the application.

Next, at step S2002, the GUI component notifies the access control unit 32 of the function attribute of the GUI component. The GUI component makes an inquiry of availability of the function (for example, copy function) in the GUI component to the access control unit 32 through the API in the function library 31.

Next, at step S2003, the access control unit 32 obtains the function use authority information of the GUI component of a user in the middle of logging in from the direct storage unit 122. At step S2004 simultaneously with the process at step S2003, the access control unit 32 makes an inquiry of availability of the function of the GUI component in the user in the middle of logging in to the print upper limit managing server 1801 through the external interface 125. At this time, for asynchronously waiting for the response of the inquiry, the processes from step S2005 to step S2011 to be described later are performed in parallel during response standby.

Next, step S2005, the access control unit 32 reads out the availability determination history of the function in the GUI component in the user in the middle of logging in from the indirect storage unit 123 to the direct storage unit 122 and obtains it.

Next, at step S2006, the access control unit 32 determines whether or not the user in the middle of logging in has the use authority of the function in the GUI component from the function use authority information of the user in the middle of logging in obtained at step S2003.

In a case where at step S2006, it is determined at this time that the user in the middle of logging in has the use authority of the function of the GUI component, the process goes to step S2007.

In a case where at step S2006, it is determined at this time that the user in the middle of logging in does not have the use authority of the function in the GUI component, the process goes to step S2009.

Next, at step S2007, the access control unit 32 refers to the availability determination history of the function of the GUI component obtained at step S2005 to determine the result of the past availability determination.

Here, “past” means a state before the process at step S2007 is performed.

In a case where at step S2007, the use determination history of the function in the GUI component in the past in a user in the middle of logging in is “YES (available)”, the process goes to step S2008.

In a case where at step S2007, the use determination history of the function in the GUI component in the past in the user in the middle of logging in is “NO (not available)”, the process goes to step S2009.

At step S2007, the access control unit 32 associates a command for displaying the GUI component on a display in a display state in accordance with the result of the past response to the inquiry in the processes in FIGS. 5 and 15 with the GUI component.

Next, at step S2009, the GUI component receives the notification that use of the function of the function in the GUI component is “NO” or the notification that use authority of the function in the GUI component is “NO” from the access control unit 32 to perform the processing of correcting and setting the GUI component to a gray-out state for the displaying.

Next, at step S2008, the GUI component receives the notification that use of the function of the function in the GUI component is “YES (available)” or the notification that use authority of the function in the GUI component is “YES (available)” from the access control unit 32 to perform the regular display processing of the GUI component.

As soon as the access control unit 32 receives the result of the response at this time from step S2008 or step S2009, the access control unit 32 associates a command for changing the display state of the GUI component to the display state in accordance with the result of the response at this time with the GUI component. From step S2008 or S2009, the access control unit 32 controls the GUI component in the display state determined at step S2006 or step S2007 to be displayed on the display.

It should be noted that “at this time” described above means “at a point of performing the process at step S2008 or step S2009”.

Next, at step S2010, the GUT component or the access control unit 32 stores the determination result of the availability of the function in the GUI component included in the notification received at the GUI component in the indirect storage unit 123 as the availability determination history.

Next, at step S2011, the GUI component ends the process once.

At steps S2003 to S2011 described above, the access control unit 32 controls the GUI component in the display state in accordance with the result of the response to the inquiry in the past inquiry process in the processes in FIG. 5 and in FIG. 15 to be displayed on the display.

As soon as the access control unit 32 receives the response result to the inquiry of availability of the print to the print upper limit managing server 1801 at step S2004 at step S2012, the access control unit 32 once more starts with the process.

Next, at step S2013 the following process is performed. That is, the access control unit 32 once more determines availability of the function in the GUI component in a user in the middle of logging in based upon the response result of the inquiry about availability of the print to the print upper limit managing server 1801 and the use authority in the user in the middle of logging in obtained at step S2003.

When the access control unit 32 once more determines that use of the function in the GUI component is “YES (available)” at step S2013, the process goes to step S2014.

When the access control unit 32 once more determines that use of the function in the GUI component is “NO (not available)” at step S2013, the process goes to step S2015.

When at step S2014, the GUI component receives a notification that use of the function in the GUI component is “YES (available)”, the GUI component is redrawn to perform a regular display process.

When at step S2015, the GUI component receives a notification that use of the function in the GUI component is “NO”, the process of redrawing the GUI component and correcting and setting the GUI component to a gray-out state is performed.

As soon as the access control unit 32 receives the response result to the inquiry of availability of the print to the print upper limit managing server 1801 at step S2004 from step S2013 to step S2015, the following process is performed. That is, the access control unit 32 is so configured as to once more determine availability of the function specified by the function information to display the GUI component in a display state in accordance with the result of the re-determination on the display.

Next, at step S2016, the GUI component or the access control unit 32 once more stores the determination result of the availability of the function in the GUI component included in the notification received at the GUI component in the indirect storage unit 123 as the availability determination history, and at step S2017, the display process ends.

As soon as the access control unit 32 receives the response result to the inquiry in this time's inquiry process in the processes in FIG. 5 and FIG. 15 from step S2012 to step S2017, the following process is performed. That is, the access control unit 32 is so configured as to display the GUI component in a display state in accordance with the response result to the inquiry in this time's inquiry process on the display unit.

In a flow chart in FIG. 20, the processes subsequent to step S2003 and the processes subsequent to step S2004 are performed in parallel. However, by referring to the use authority of the function in the GUI component in a user obtained at step S2003, the processes subsequent to step $2004 may be performed only in a case where the use authority exists.

### Fifth Embodiment

Hereinafter, a fifth embodiment will be explained with reference to the drawings. In the following fifth embodiment, in a case where the function attribute is not attached to the GUI component, based upon an occurrence history of error information (error history) of unavailability caused by the past GUI operation, the display state of the GUI component at the next time is changed so as not to generate the error once more. An operational environment of the fifth embodiment is the same as in the third embodiment.

In the present embodiment, in the same way as in the third embodiment, the source codes realizing the GUI components in the first and second embodiments can be installed as operating as the applications 1 to 3 (41 to 43) activating in the platform unit 20.

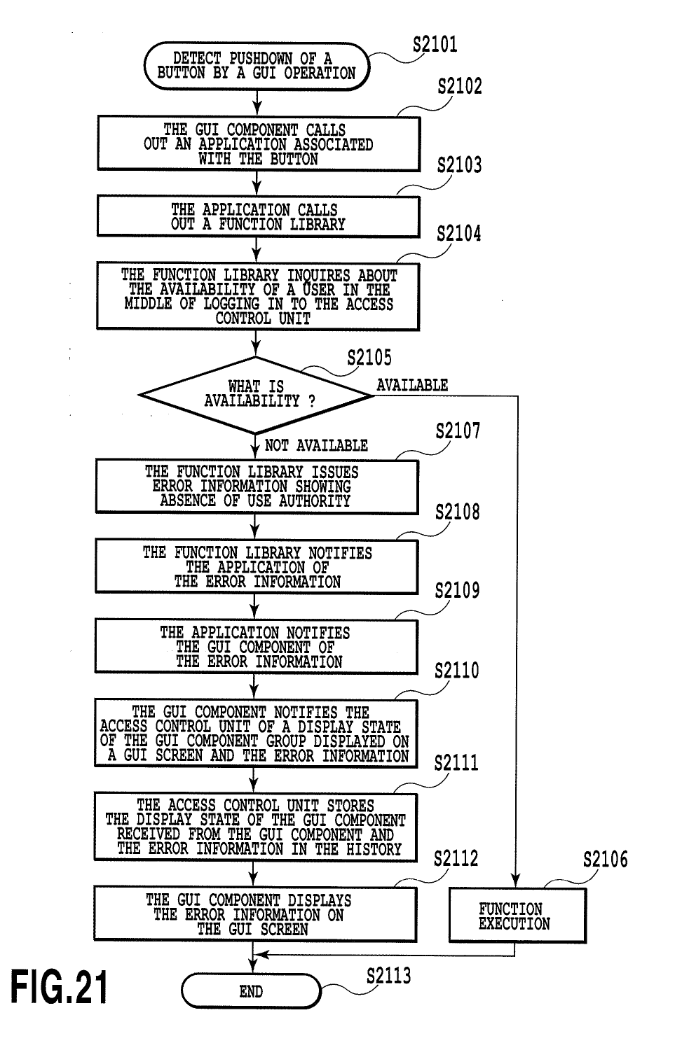

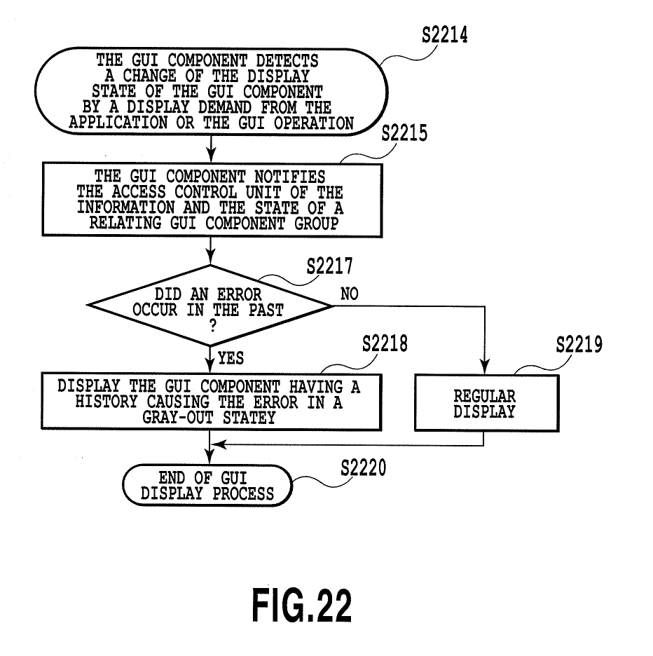

Hereinafter, an operation in the present embodiment will be explained with reference to flow charts in FIG. 21 and FIG. 22.

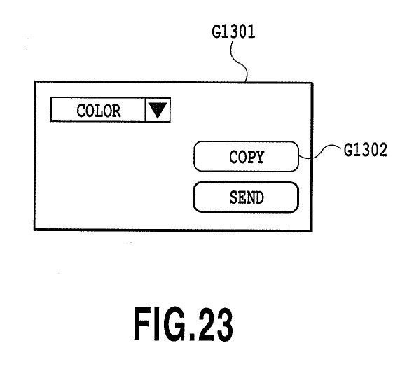

Herein, an explanation of the operation in the present embodiment is, as shown in FIG. 23, made assuming a case where a user pushes down the copy button G1302 in a state of selecting “color” from the list box in the GUI screen operation of the application, as an example.

The panel G1301 monitors an operation of the GUI component on a panel, thereby making it possible to have information of a state change or an occurrence event of the GUT component on the panel. In the following explanation, a user is assumed to in advance log into the image forming device, for example.

First, at step S2101 in FIG. 21, the image forming device starts with an operation by detecting a user's pushdown of the copy button G1302. At this time, the panel G1301 also detects the pushdown of the button G1302 and stores the detection in the direct storage unit 122.

Next, at step S2102, the copy button G1302 calls out an application program at button-pushdown associated with the button.

Next, at step S2103, the application program calls out the function library 31 providing the function of the copy button G1302.

Next, at step S2104, the function library 31 called out at step S2103 refers to the direct storage unit 122 to obtain user information in the user in the middle of logging in. The function library 31 makes an inquiry of availability of the function of the copy button G1302 in the user designated by the user information to the access control unit 32.

Next, at step S2105, the function library 31 determines whether or not the user in the middle of logging in can use the copy button G1302.

Here, the function library 31 determines whether or not the user in the middle of logging in has the use authority of the function (copy) specified by the function information associated with the copy button G1302. In a case where at step S2105, it is determined that the use of the copy button G1302 is “YES (available)”, the process goes to step S2106.

On the other hand, in a case where at step S2105, it is determined that the use of the copy button G1302 is “NO”, the process goes to step S2107.

That is, in a case where at step S2105, it is determined that the user in the middle of logging in has no use authority of the copy button G1302, the process goes to step S2107.

At step S2106, the function execution library 31 calls out the hardware function in the image forming device through the platform unit 20 to perform the copy process and at step S2113, the process ends.

At step S2107, the function library 31 issues error information showing that the user in the middle of logging in has no use authority of the function in the copy button G1302.

Next, at step S2108, the function execution library 31 notifies the application of the error information.

Next, at step S2109, the application notifies any of the GUI components of the notified error information. In the present embodiment, the panel G1301 receives the notification of the error information, as an example.

Next, at step S2110, the panel G1301 which has received the error information notifies the access control unit 32 of the information of the GUI components on the panel (identification information and the display state of the GUI components), a final event causing the error, and the received error information.

Next, at step S2111, the access control unit 32 stores the notified error information as well as information identifying the user in the middle of logging in as an error history in the direct storage unit 122 and in the indirect storage unit 123.

Further, at step S2111, the access control unit 32 stores the error history made by associating the error information with the display state of the GUI component at the time of the error occurrence in the direct storage unit 122 and in the indirect storage unit 123.

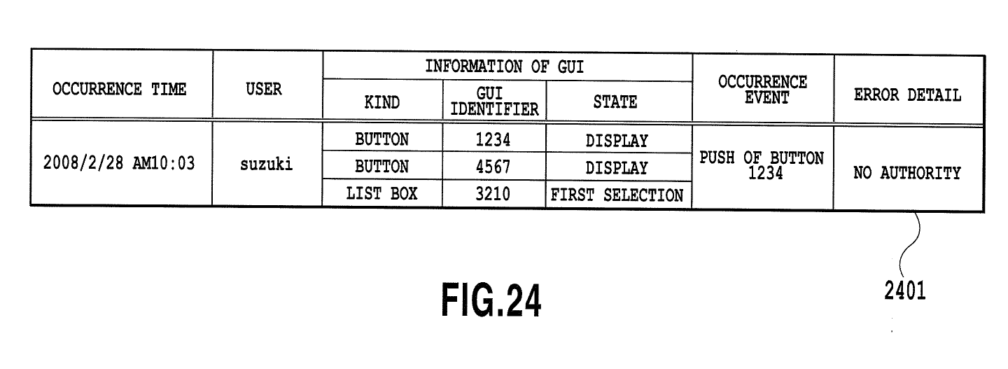

For example, the information to be recorded is as shown in a table 2401 in FIG. 24.

Next, at step S2112, the panel G1301 displays the error information on the panel and at step S2113, the process once ends.

Next, by referring to a flow chart in FIG. 22, a GUI screen redisplay process of the application after the above process will be explained.

First, at step S2214 in FIG. 22, the panel G1301 starts with the display process of the GUI screen by detecting a GUI screen display demand from the application or a state change of the GUI component by an operation of a user.

Next, at step S2215, the panel G1301 notifies the access control unit 32 of information (GUI kind and identification information) and states of GUI components on a panel and makes an inquiry of YES/NO of the display. Here, the GUI components include a copy button G1302, a SEND button G1303, and a list box G1304, for example.

Next, at step S2217, the access control unit 32 which has received the notification at step S2215 obtains information of a user in the middle of logging in from the direct storage unit 122. The access control unit 32 compares the user's information with the stored error history by the process at step S2111 in FIG. 21 to determine whether or not an error exists in the past in the display state of the present application.

Next, in a case where at step S2217, it is determined that the error exists in the past, the process goes to step S2218.

Next, in a case where at step S2217, it is determined that the error does not exist in the past, the process goes to step S2219.

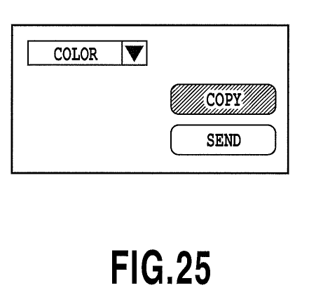

At step S2218, for example, the panel G1301 is notified that a non-authority error occurs under the pushdown of the copy button G1302 at 1234 of the identifier. The panel G1301 receives this notification to perform the process of setting the copy button G1301 to a gray-out state for the displaying, performing the display process to a display as shown in FIG. 25. At step S2220, the process ends.

At step S2217, the panel G1301 receives the notification that the error history does not exist and performs a regular GUI component display process. At step S2220, the process ends.

By the processes at steps S2217 to S2219 as described above, the panel G1302 refers to the error history, thereby determining a display state of the GUI component at the next time.

In a case where the access control unit 32 detects that a user's management table 1101 and the function use authority information (table 1201 in FIG. 12) stored in the indirect storage unit 123 are changed, the access control unit 32 deletes the error history in regard to the changed user.

In the present embodiment, the access control unit 32 performs the storage of and the reference to the error history, and the comparison with the state of the GUI component, but the GUI component may perform them.

### Embodiment Other than the Above Embodiments

In each of the third to fifth embodiments, the GUI component, the function library 31, and the access control unit 32 are configured to be divided as separate programs, but a part or all of the functions in the function library 31 or the access control unit 32 may be attached to the GUI component.

As described above, according to the present invention, a user's management table 1101 and the function use authority information of each user in the table 1201 are used, thereby facilitating the development of the GUI in accordance with the function restriction determining information transmitted from the application platform.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-203212, filed Aug. 6, 2008, which is hereby incorporated by reference herein in its entirety.

What is claimed is:

1. A program used as a development tool kit for supporting development of an application, the program being storable in a computer readable recording medium,
wherein the program is configured in such a manner that when an application associates a GUI component arranged on a display screen displayed on display unit with function information, a computer performs an association step of automatically associating a command for making an inquiry to managing unit for managing information on availability of a function specified by the function information, with the application.

2. A program according to claim 1, wherein the association step, when the GUI component is associated with the function information, further automatically associates a command for determining a display state of the GUI component on the display screen in accordance with the result of the response to making the inquiry to the managing unit for managing the information on the availability of the function specified by the function information, with the application.

3. A program according to claim 2, wherein generation of a source code of the GUI component is made using a table including information in relation to a method of displaying the GUI component.

4. A program according to claim 3, wherein in a case where a plurality of the GUI components associated with the function information exist, the program is configured to make the computer perform a step of determining the display state of the GUI component in accordance with the response result from the managing unit for managing the information on the availability of the function specified by the function information.

5. A program according to claim 3, wherein in a case where a plurality of the GUI components associated with the function information exist, when the display state of the GUI component changes, the program is configured to make the computer perform a step of determining a display state of another GUI component in regard to the GUI component in accordance with the information on the availability of the function specified by the function information.

6. A program according to claim 3, wherein the information on the availability of the function is information on any of use authority and the number of the usable times to the function for each user.

7. A program storable in a computer readable recording medium comprising:
a receiving step of receiving a command for displaying a GUI component associated with function information on display unit from an application;
an inquiring step of making an inquiry to managing unit for managing information on availability of a function specified by the function information when the command is received in the receiving step; and
a controlling step of controlling the GUI component in a display state in accordance with the result of the response to the inquiry in the inquiring step to be displayed on the display unit, wherein the program is configured to make a computer perform the steps.

8. A program according to claim 7, wherein the program is configured to make the computer perform the controlling step of controlling the GUI component in the display state in accordance with the result of the response to the inquiry in the past inquiring step to be displayed on the display unit; and as soon as receiving the result of the response to the inquiry in the inquiring step at this time, the controlling step of controlling the GUI component in the display state in accordance with the result of the response to be displayed on the display unit.

9. A program according to claim 8, wherein the inquiring step, in a case where a plurality of the managing unit for managing the information in regard to the availability of the function specified by the function information exist, makes an inquiry to each managing unit, the program is configured to make the computer perform:
a determining step of, in a case of receiving a response from one managing unit out of the plurality of the managing unit, determining the availability of the function specified by the function information from the result of the response and the result of the response to the inquiry in the past inquiring step to determine a display state of the GUI component;
a controlling step of controlling the GUI component in the display state determined by the determining step to be display on the display unit; and
a controlling step of re-determining the availability of the function specified by the function information as soon as receiving the response result from the managing unit which does not respond to the inquiry by the inquiring step to control the GUI component in a display state in accordance with the result of the re-determination to be displayed on the display unit.

10. A program storable in a computer readable recording medium comprising:
a use authority determining step of determining use authority of a function specified by function information;
a step of issuing error information showing that the use authority does not exist in a case where the use authority determining step determines that the use authority does not exist;
a step of storing an error history made by associating the error information with a display state of a GUI component at the time an error occurs; and
a step of determining a display state of the GUI component at the next time by referring to the error history, wherein the program is configured to make a computer perform the steps.

11. A program according to claim 10, wherein the program is configured to make the computer perform a step of eliminating the error history by detecting that setting of the use authority is changed.

12. A program storable in a computer readable recording medium comprising:
a receiving step of receiving a command for displaying a GUI component associated with function information on display unit from an application;
an inquiring step of making an inquiry to managing unit for managing information on availability of a function specified by the function information using information found by summing function attribute values of the GUI component at the time of receiving the command in the receiving step; and
a controlling step of controlling the GUI component in a display state in accordance with a result of a response to the inquiry in the inquiring step to be displayed on the display unit, wherein the program is configured to make a computer perform the steps.
